(19) United States
(12) Patent Application Publication
(10) Pub. No.: US 2005/0107524 A1
(43) Pub. Date: May 19, 2005

(54) Enhanced protective coating for concrete, steel, wood and other surfaces

(75) Inventors: Richard S. Himmelwright, Wilbraham, MA (US); Douglas Cahill, Belcher Town, MA (US)

Correspondence Address: BURNS DOANE SWECKER & MATHIS L L P, POST OFFICE BOX 1404, ALEXANDRIA, VA, 22313-1404, US

(73) Assignee: Cold Spring Technology, Inc., Three Rivers, MA (US)

(21) Appl. No.: 10/937,606

(22) Filed: Sep. 10, 2004

Related U.S. Application Data
(60) Provisional application No. 60/501,428, filed on Sep. 10, 2003.

(51) Int. Cl. C08K 5/34

(52) U.S. Cl. 524/589

(57) ABSTRACT

An aliphatic hybrid polyurethane/polyurea protective coating intended for use on concrete, steel, wood and other surfaces is provided, which coating exhibits excellent properties of durability and flexibility. The protective coating uses chemical components from urethane/urea systems in a unique way to generate beneficial systems.

### REFERENCE TO PRIOR APPLICATIONS

This application claims the benefit of U.S. Provisional Application No. 60/501,428, filed Sep. 10, 2003.

### BACKGROUND OF THE INVENTION

1. Field of the Invention

The present invention relates to a protective coating for various surfaces. In particular, the present invention relates to a protective coating for concrete, steel and wood.

2. Description of the Related Art

The use of polymer coatings to protect surfaces and enhance functional properties of materials is well known. The development of many different polymer systems has led to many new applications and materials. Some of these systems like epoxies, nylon, polyurethanes and polyureas have very useful properties. The useful properties of many of the plastic coatings mentioned above cannot be obtained on substrate surfaces, however, due to the difficulty in formulating easily applied coatings. Overcoming this problem would be of great advantage to the industry.

One particular surface to which coatings are often applied is that of wood. The coating of wood with various polymer products has been well established and is currently a very large worldwide industry. Wood is a major construction material but must be protected from degradation by weather, sunlight, abrasion from use, and many other factors. The application of coatings to wood has provided a method of extending the useful life of wood products and has also provided many, varied aesthetic improvements.

Typical major drawbacks in the use of coating products is the presence in most instances of a carrier or solvent that allows the paint or coating to be applied in a liquid form. The coating then needs to be dried to provide a continuous coating or film on the wood. The presence of this carrier or solvent leads to significant quantities or organic chemicals that are allowed to evaporate into the atmosphere and thus become pollutants which is a very undesirable situation.

In addition to paints and coatings there are many treatments that have been developed for the preservation of wood. One of these treatments, in particular, is referred to as the CCA treatment, which involves copper, chromium and arsenic. The arsenic in particular has been demonstrated to be linked with certain diseases such as cancer, particularly in children. Thus the use of this type of wood treatment has nearly been completely halted. However, there are large amounts of structures in place that contain CCA treated wood that need to be addressed.

It is therefore an object of the present invention to provide a novel, enhanced protective coating for various surfaces, especially concrete, steel and wood, which coating can help overcome many of the aforediscussed problems and issues.

### SUMMARY OF THE INVENTION

The present invention provides a polyurethane/polyurea protective coating produced by reacting an isocyanate with a polyol in the presence of a diamine or triamine, preferably a low molecular weight diamine or triamine, and a catalyst. Preferably, the polyol is a polyester polyol, a polyether polyol, an acrylic polyol or mixtures thereof. The catalyst is preferably a metal based catalyst such as a tin, zirconium or bismuth based catalyst.

The protective coatings of the present invention are intended for use in high pressure impingement mixing spray systems. These systems can utilize 100% solids fluids which do not contain a solvent and thus are zero (or near zero) VOC coatings. One of the surprising results that has been obtained is that several amines utilized in other cured systems can be formulated into sprayable fluids and provide an excellent coating with very useful properties.

### DETAILED DESCRIPTION OF THE PREFERRED EMBODIMENTS

The coatings of the present invention are targeted for the protection of many different surfaces. Materials such as concrete, steel, aluminum, wood and others degrade when exposed to UV radiation, humidity and various chemicals. The protective coatings of this invention dramatically reduce or eliminate the detrimental effects of exposure to these conditions. It has been found that several low molecular weight, highly reactive amines can be combined with polyols and isocyanates to yield very useful and easy to apply protective coatings. These final coatings are hybrid polyurethane/polyurea coatings.

The polyol employed in preparing the coatings of the present invention can be any suitable polyol reactive with an isocyanate, and is preferably a polyester polyol, polyether polyol, an acrylic polyol or mixture thereof. Indeed, it is most preferred that a mixture of polyester polyols, together with a polyether polyol be employed. The amine can be any suitably reactive diamine or triamine, preferably an aliphatic diamine or triamine. The presence of primary amines can render the composition too reactive so that when the components are mixed the coating cannot be easily applied. Thus, the presence of primary amines is not desirable. Preferred aliphatic amines include polyoxypropylenetriamine, menthanediamine, 2-methylpentamethylenediamine, those available under the trademark Clearlink 1000™ or the like. The amount of diamine or tramine that is present in the final coating generally ranges from 0.5 to 20 percent by weight of total solids.

The protective coating is generally applied by preparing a first formulation, e.g. formulation A, comprised of the isocyanate compounds. The isocyanate compounds can comprise any suitable isocyanate, especially dimers and trimers. In a preferred embodiment a mixture of isocyanate dimer and trimer is preferred. Among the preferred diisocyanates is 4-4′-diphenyl methane diiocyanate. A formulation B comprising the polyol and amine is also prepared, and then mixed with formulation A for application onto the substrate. A suitable catalyst can be placed in either formulation, or both if desired

Since the formulations are of solids, and no solvent is employed, the mixing can involve a static mixer and the formulation and the coating are applied by a brush or squeegee. As well, in a most preferred embodiment, however, it has been surprisingly found that the system can be formulated into sprayable fluids, even though comprised of solids, with the coating being sprayed onto the substrate to be coated. A high pressure impingement mixing/spray system is most preferred for applying the protective coatings of the present invention. Most preferred is a zero solvent high pressure spray process for application of the coating. Such high pressure impingement spray apparatus are commercially available, for example, from Gusmer, Graco, Glas-Craft and other companies. The high pressure spraying is generally conducted at a NCO/NH₂—OH ratio from about 0.9 to 1.3, and most preferably at a ratio from about 1.05 to 1.10. Once the coating has been applied, it is generally utilized in a thickness of from 0.1 mil to 100 mil.

The coatings of the present invention are useful in coating wood, concrete, steel and other surfaces as a protective coating. The coating on structures, articles or items made of such materials provide an environmentally friendly approach to preventing degradation by weather, UV radiation, abrasion, and other factors, thereby preserving the overall structure. The coating also adheres well to the various surfaces. For wood, the protective coating of the present invention can have an elongation of at least 100% well adhered to the wood surface, a Shore D hardness of 30 or greater well adhered to wood surfaces, and/or an adhesion to CCA pressure treated wood and other types of wood of greater than 1 MPa (140 psi) in adhesion strength.

In one embodiment, the coatings of the present invention are used to coat an encapsulate wood, and wooden structures. The present invention provides a system for coating wooden structures or articles with a barrier coating that both prevents further degradation of the wood and also when needed provides an encapsulation coating for containing dangerous chemicals within the barrier coating and wood structure. The coating system in addition does not use any solvents and thus generates zero VOC or near zero VOC (VOC is volatile organic chemicals). The coatings in the present invention can be spray applied, brush applied, or applied by other typical painting implements. The coatings of the present invention do not utilize the traditional solvent carrier method in which a polymerizable formulation is applied to the wood surface or impregnated into the wood structure followed by during and then polymer formation. The coatings of the present invention utilize materials that are fluid during application and react instantaneously or very rapidly after being mixed and then adhere to the wood surface during final curing and hardening. During this process there is zero or near zero release of any organic chemicals into the atmosphere, all of the applied material is reacted into the final coating layer.

The coatings in the present invention have also been designated to yield a barrier layer that resists the migration of previously employed wood preservative chemicals out of the wood structure and into the environment or into contact with humans. Specifically, the barrier coatings of the present invention have been shown to contain dangerous elements such as arsenic within the wood structure. This is of high value since there is a large number of wood structures that exist using CCA (chromium, copper and arsenic) treated wood, which now must be dealt with by removal or some other method. These chemicals are often found in pressure treated wood.

### EXAMPLES 1-4

The coatings described are all two part fluids that were combined during application and cured to give hard durable surfaces. There was an “A” formulation containing the isocyanate materials and a “B” formulation containing the amines and polyols. The catalyst can be placed in either the “A” or “B” formulations depending on the catalyst used. The “A” and “B” formulations were combined via high pressure impingement mixing, static tube mixing or some other rapid mixing device. Immediately after mixing, the fluids were applied to the desired surface by high pressure spraying, squeegee spreading or some other method or combination of methods. The same isocyanate “A” formulation was used for all four coatings, each with a different B formulation. The coatings were prepared as follows:

“A” formulation for Examples 1- 4

| | % by Weight in Final Coating |
|---|---|
| Isocyanate Trimer | 40.0 |
| Isocyanate Dimer | 9.0 |
| Zirconium catalyst | 2.0 |
| Example 1 “B” formulation | |
| 1,3-Bis-Aminomethyl Cyclohexane | 8.0 |
| Polyether polyol | 20.0 |
| Polyester polyol 1 | 10.5 |
| Polyester polyol 2 | 10.5 |
| Example 2 “B” formulation | |
| Menthanediamine | 5.0 |
| Polyether polyol | 21.0 |
| Polyester polyol 1 | 11.5 |
| Polyester polyol 2 | 11.5 |
| Example 3 “B” formulation | |
| Polyoxypropylenctriamine | 5.0 |
| Polyether polyol | 21.0 |
| Polyester polyol 1 | 11.5 |
| Polyester polyol 2 | 11.5 |
| Example 4 “B” formulation | |
| 2-methylpentamethylenediamine | 5.0 |
| Polyether polyol | 21.0 |
| Polyester polyol 1 | 11.5 |
| Polyester polyol 2 | 11.5 |

The “A” and “B” formulation fluids were combined via a static mixing apparatus and applied to a desired surface and then spread with a squeegee, or the “A” and “B” formulation fluids were combined via a high pressure mixing unit such as the Glas-Craft MX Probler mixing gun. The final coating thickness in each case was from about 2 Omil to 4 Omil.

### EXAMPLE 5

Four samples of pressure treated wood were tested for arsenic at the wood surface. Samples 1 and 2 were pieces of wood pressure treated in a laboratory, with Sample 1 being uncoated and Sample 2 having a polyurethane/polyurea protective coating of the present invention. Samples 3 and 4 were pieces of pressure treated decking from a test site, with Sample 3 being uncoated and Sample 4 being coated with a polyurethane/polyurea protective coating in accordance with the present invention. Each of Samples 1-4 were wiped with a test wipe from a testing kit for arsenic treated wood, and then analyzed using SW-846 Test Methods for Evaluating Solid Waste Physical/Chemical Methods, with the arsenic determination being by EPA Method 7060A, Atomic Absorption, Furnace Technique, September 1994. The amount of arsenic detected at the surface of each wood sample by the wipe was determined to be as follows:

| | |
|---|---|
| Sample 1 - uncoated | 101.7 mg/100 cm² of arsenic |
| Sample 2 - coated | 0.7 mg/100 cm² of arsenic |
| Sample 3 - uncoated | 49.7 mg/100 cm² of arsenic |
| Sample 4 - coated | <0.3 mg/100 cm² of arsenic |

The foregoing results show the effectiveness of the protective coating of the present invention in containing the arsenic from a pressure treatment within the wood.

While the invention has been described with prepared embodiments, it is to be understood that variations and modification may be resorted to as will be apparent to those skilled in the art. Such variations and modifications are to be considered within the purview and the scope of the claims appended hereto.

1. An aliphatic polyurethane/polyurea protective coating produced by reacting an isocyanate with a polyol in the presence of a diamine or triamine, and a catalyst.

2. The coating of claim 1, wherein the polyol is a polyester polyol, a polyether polyol, an acrylic polyol or mixture thereof; the diamine is an aliphatic diamine; and the catalyst is tin, zirconium or bismuth based.

3. The coating of claim 1, wherein the diamine or triamine is present in the range of 0.5% to 20% by weight of total solids.

4. The coating of claim 2, wherein the amount of diamine in the coating ranges from 0.5% to 20% by weight of the total solids.

5. The coating of claim 1, wherein the coating on a substrate is utilized in a thicknesses of 0.1 mil to 100 mil (2.5 μM to 2500 μM).

6. The coating of claim 1, wherein the amine is comprised of polyoxypropylenetriamine, menthanediamine, or 2-methylpentamethylenediamine.

7. A process for coating a substrate with the coating of claim 1, which comprises applying the coating to a substrate by a zero solvent high pressure spray process.

8. The process of claim 7, wherein the substrate comprises wood, concrete or steel.

9. The process of claim 7, wherein the substrate is wood, which has been pressure treated.

10. A process for coating a substrate which comprises
(i) preparing a solids formulation A which comprises at least one isocyanate compound;
(ii) preparing a solids formulation B comprising a polyol and a diamine or triamine;
(iii) mixing the solids formulations A and B by use of a rapid mixing device; and
(iv) applying the mixture to a substrate.

11. The process of claim 10, wherein the mixing is achieved by a high pressure impingement mixer.

12. The process of claim 10, wherein the mixing is achieved by static tube mixing.

13. The process of claim 10, wherein the mixture is applied to a concrete, steel or wood substrate.

14. The process of claim 13, wherein the substrate is pressure-treated wood.

15. The process of claim 10, wherein the mixture is applied to the substrate by high pressure spraying.

16. The process of claim 15, wherein the mixture is applied at a NCO/NH₂—OH ratio from about 0.9 to 1.3.

17. The process of claim 16, wherein the ratio is from about 1.05 to 1.10.

18. The process of claim 10, wherein a catalyst is contained in either formulation A or B.

19. A wooden article coated with the protective coating of claim 1.

20. A concrete item coated with the protective coating of claim 1.

21. A steel item coated with the protective coating of claim 1.

22. The wooden article of claim 19, wherein the wooden article is a pressure treated wood item.
